(19) United States
(12) Patent Application Publication
(10) Pub. No.: US 2025/0010534 A1
(43) Pub. Date: Jan. 9, 2025

(54) METHOD FOR MANUFACTURING PANELS

(71) Applicant: UNILIN, BV, Wielsbeke (BE)

(72) Inventor: Julien F. BRUNET, Wielsbeke (BE)

(21) Appl. No.: 18/711,691

(22) PCT Filed: Nov. 24, 2022
(86) PCT No.: PCT/IB2022/061383

§ 371 Date: May 20, 2024

Related U.S. Application Data
(60) Provisional application No. 63/283,652, filed on Nov. 29, 2021.

(51) Int. Cl. B29C 48/00; B29K 101/12; B29K 105/16; B29K 509/00; B29L 31/00

(52) U.S. Cl. CPC B29C 48/0022; B29K 2101/12; B29K 2105/16; B29K 2509/00; B29L 2031/722; B29L 2031/732

(57) ABSTRACT

A method for manufacturing panels including a substrate and a decorative top layer, includes at least: providing the substrate at least in part; removing a portion of the substrate by means of at least one scraping tool. In another aspect, the method for manufacturing panels includes a substrate and a decorative top layer such that the substrate is provided by an extrusion process at least in part; and a portion of the substrate is removed by a removal means. The method for manufacturing panels may include a substrate and a decorative top layer, such that the substrate is provided in an orientation with an upward directed surface and a downward directed surface; and provides a decorative top layer onto the downward directed surface of the substrate.

### METHOD FOR MANUFACTURING PANELS

The present invention pertains to the technical field of methods for manufacturing panels.

In particular, the invention relates to a method for manufacturing panels comprising a substrate and a decorative top layer applied thereon. More particularly, the invention relates to methods for manufacturing panels, wherein a portion of said substrate may be removed by a removal means.

The panels comprising a substrate, wherein a substrate is provided with grooves typically on the side facing the sub-floor are known for example from EP 2 877 649 and US 2020/0308846. Such grooves are typically designed to reduce the weight and/or material content. EP′649 concerns a panel and a method for producing a panel comprising a surface layer, a core and a backing layer, wherein all three layers comprise wood fibers and thermosetting resins. Both the core and the backing layer of the panel of EP′649 comprises grooves in the rear side, i.e. the side facing the sub-floor. The grooves provided in the core are essentially parallel to the long edges of the panel. US′846 relates to a method for providing grooves into a mineral based substrate core materials. Providing the grooves in the above-mentioned prior art is performed in the late-stage of manufacturing of panels, i.e. in a post-sawing or after-milling sections of production lines. As such, providing of such grooves is limited to batch producing volumes of such panels, and lack suitability for production on a larger scale. Finally, the grooves are typically provided by milling or sawing of the substrate, which leads to generation of dust particles, which cause pollution of the line and represent the health hazards for workers. Pollution of the line leads in itself to additional downtime which is undesirable.

In the field of decorative panels, panels based on plastic materials, such as soft, semi-rigid or rigid PVC (polyvinyl chloride), also called vinyl tiles, are gaining more and more importance as an alternative for wood-based materials. Panels based on plastic materials are visually appealing, inexpensive and relatively easy to install. Moreover, such panels are suitable for both indoor and outdoor uses.

The reduction of the material content within the substrate may be of interest in plastic panels, at least for ecological, economical and logistics point of view. However, finding a proper balance between the reduction of the used material, while at least keeping mechanical properties of such panels remains challenging. In order to address this, WO 2020/161609 employs panels with highly dense substrate material, which substrate is provided with the internal spaces or spaces on the bottom side. The density of the panel of WO′609 provides for mechanical characteristics, while spaces increase ergonomics and ease the transportation of such panels. In order to obtain these internal spaces and/or the spaces on the bottom side, the method for producing such panels includes consolidating of the core after such spaces are provided in the core. To achieve this, the method of WO′609 typically involves a step of employing a mold or a specific die, such as a T-die having a comb-like bottom side. Thus, the substrate is formed to have said spaces and no additional removal is required. Working in a repeatable manner with a modified T-die is however very challenging, and heavily relies on a suitable steady rheology of the substrate material to be formed by the T-die.

WO 2021/018918 concerns a method for forming a decorative panel provided with a plurality of grooves situated merely within a center position of the lower or the upper side of a core, providing thereby a distance of said plurality of grooves from the coupling profiles. The method for manufacturing said decorative panels is suited for provision of extruded core materials, particularly if the grooves of the core are formed while the material is still sufficiently liquified and therefore deformable. No additional removal is needed. However, the step of providing the grooves requires thermoforming, and is challenging to execute in a repeatable manner.

The present invention is in the first place aiming at an alternative, more versatile and/or more economic method for manufacturing panels, preferably not leading to health and pollution issues and/or being more easily controllable. In accordance with preferred embodiments a solution is offered for one or more of the problems associated with methods for manufacturing of panels of the prior art.

In accordance with a first independent aspect, the present invention relates to a method for manufacturing panels comprising a substrate and a decorative top layer, wherein said method comprises at least the following steps:
providing said substrate at least in part;
removing a portion of said substrate by means of at least one scraping tool,
   wherein said substrate is provided in an orientation with an upward directed surface and a downward directed surface.

According to the method of the present invention, at least a portion of the substrate material is removed by at least one scraping tool. Such scraping tool may be in the form of at least one knife or a sharp edge tube, or the like, and serves as a means for removal of the substrate. By removing of at least a portion of the substrate by at least one scraping tool, the generation of dust is minimized or avoided, as compared to a method where e.g. the recesses are milled. Thus, the method of the invention is more safe for the workers, more environmentally friendly and/or less polluting for the manufacturing line. Thereby a manufacturing line with less downtime may be obtained.

The method of the invention is particularly suitable for panels which feature a synthetic substrate material such as a thermoplastic substrate, a solid plastic composite (SPC) substrate or filled plastic composite. The method of the first aspect of the invention is particularly suited for panels which have the substrate comprising a rigid PVC (PolyVinyl Chloride) core filled by mineral fillers, such as chalk, limestone, talc, and the like. The rigid PVC core is preferably free from plasticizer, or comprises plasticizer at a rate less than 5 phr (parts per hundredth of the PVC resin). Preferably, a filler ratio of more than 1 part per part PVC is used, and preferably less than 6.5 parts of filer per part of PVC. In this particular embodiment, the substrate is preferably not foamed.

The method according to the first aspect of the invention is also suitable for a foamed thermoplastic substrate, such as so-called WPC (Waterproof Plastic Composite), namely a floor panel having a substrate comprising closed cell foamed PVC, and the like.

Preferably, said portion of the substrate is removed in order to from recesses in one or both of said upward and downward directed surfaces. Said recesses may be in the form of grooves, dashed or dotted recesses. The length and depth of such recesses can be changed, for example by positioning said scraping tool in the direction perpendicular to the respective surface, and/or by starting or stopping the engagement with the respective surface of the substrate. The length, depth and spacing of said recesses can be varied based on the desired substrate reduction and the characteristics of the substrate. For this reason, the scraping tool offers a good flexibility of the method according to the first aspect of the invention.

In a preferred embodiment of the method according to a first aspect of the invention, said step of removing of a portion of said substrate is performed on at least one, and preferably on only one of the upward directed surface or the downward directed surface of the substrate.

In a preferred embodiment, the step of removing of a portion of the substrate is performed on the downward directed surface of the substrate. Said removal is preferably done in the longitudinal direction, i.e. following the length of the panels. By removing a portion of the substrate a recess in a form of a groove, a spot- or dash-shaped recess and the like, may be created. Preferably said substrate comprises at least two recesses, more preferably a plurality of such recesses.

In an alternative embodiment, the step of removing of a portion of the substrate is performed on the upward directed surface of the substrate. This is preferably the surface of the substrate upon which the decorative top layer is, or shall be applied. Such position of recesses obtainable by the removal of the substrate could be such that it enhances the relief structure of the eventual decorative top layer. In a particularly preferred embodiment, said at least one scraping tool may be used to create a bevel structure in the upward directed surface of the substrate. Such structured surface may then be provided with said decorative top layer, such that the decorative top layer follows the contours of the structured surface. For example, a panel may be obtained where the decorative top layer extends uninterruptedly from the general upper surface onto a bevel, and preferably up to the side edge. Said bevel structure enhances the appearance of the decorative top layer, giving it a more authentic look, for example a more authentic wood panel look. The present invention wherein a scraping tool is used to structure the surface of the substrate, preferably before application of said decorative top layer, provides a convenient manner to obtain deeply structured panels. In another particularly preferred embodiment, portions of the substrate are removed from the upward directed surface of said substrate, to produce a panel with a pronounced, scraped wood look.

In another alternative embodiment, the removal of a portion of the substrate can be performed on both an upward directed surface and a downward directed surface of the substrate of the panel. Such embodiment may provide for a light weight panel of a pronounced aesthetic appearance

In a particularly preferred embodiment of the invention, said at least one scraping tool is positionable. The positionable tool provides for a flexibile way of varying recesses concerning their form, length, depth and/or denseness, i.e. spacing or a distance between them. By using such scraper tool, discontinuous operation steps are preferably omitted, such as method steps involving employing a sawing or milling means which has to be stopped after each panel batch exits the sawing section. Said at least one scraping tool preferably engages intermittently with at least one surface of the substrate, wherein positioning of said at least one scraping tool is used to start and stop the engagement with the surface, i.e. positioning of said at least one scraping tool is used to start and stop the removing of a portion of the substrate. Said positioning allows operating the scraping tool in a continuous manner, i.e. minimizes stopping of the production line upon finish of a batch. Thus, the method according to this preferred embodiment provides for a more fluent and continuous method for production of panels.

Said scraping tool is preferably able to be put forth and/or retractable, wherein at least the position in which the scraping tool is put forth, is a position in which the scraping tool engages with the substrate.

The scraping tool may be in the form of a knife, a hollow cylinder with a sharp edge, a needle, a cone or any other geometrical body.

In a particularly preferred embodiment, said scraping tool, and preferably at least two scraping tools, are provided on a support means. Said support means is preferably a positionable holder, such as a cylinder, wherein the positioning of the holder may result in the scraping tool be put forth or retracted. For example the scraping tool may be present on the circumference on an indexable cylinder, wherein rotation of the cylinder engages or disengages the scraping tool with the substrate and/or controls the depth of engagement.

In a preferred embodiment, said scraping tool is heated, preferably to a temperature above the glass transition temperature of said substrate.

In a further preferred embodiment of the method according to the first aspect of the invention said providing of the substrate at least comprises extruding a part of said substrate. The method of the invention is particularly suited for a production of panels which feature a synthetic core, i.e. a core comprising a thermoplastic material.

In a further preferred embodiment, said part of the substrate is provided in a continuous manner. Preferably, removing of a portion of the substrate is performed in-line with extruding of said substrate. More particularly, the method according to this preferred embodiment is particularly suited for substrate material which may be extruded and wherefrom the portion of the substrate material may be removed in-line with an extrusion process. The positioning of the scraping tool and the possibility to apply it in-line with the extrusion process allows a direct removal of a portion of the substrate preferably right after the extruder section, for example within 5 meters from the T-die.

In the preferred embodiment, the method according to the first aspect of the invention allows for adjusting the thickness of the substrate material, e.g. of a substrate comprising thermoplastic material, more particularly a filled thermoplastic material or an SPC. In a particularly preferred embodiment, this can be done shaving of a portion of the substrate by means of said at least one scraping tool.

According to a preferred embodiment of the method of the invention, the substrate is only partially consolidated upon removing said portion of said substrate and/or, in case of substrates comprising thermoplastic material, the removal of the portion of the substrate by means of said at least one scraping tool is done with said substrate at a temperature above the glass transition temperature of the main thermoplastic polymer available in said substrate. This allows removing of the portion of the substrate with less force requirements. Preferably said substrate is still in a heated condition due to an upstream operation, for example an extrusion operation used to provide said substrate, when said portion of said substrate is being removed. In this way additional heating steps may be avoided, and the chances of deformation and destruction of the panels caused by temperature variations is lessened.

In an alternative embodiment, the part of said substrate is fully consolidated upon said removing a portion of said substrate by means of said scraping tool and/or, in case of substrates comprising thermoplastic material, said substrate is at a temperature below the glass transition temperature of the main thermoplastic polymer used in said substrate upon said removing a portion of said substrate by means of said scraping tool. In such case no additional heating steps are required.

It is noted that, in the case of substrates comprising thermoplastic material, preferably, said thermoplastic material comprises less than 5 phr of plasticizer, or is plasticizer-free. Alternatively, the thermoplastic material comprises plasticizer in a concentration of at least 5 phr, preferably at least 12 phr.

In a further preferred embodiment, the method according to the first aspect of the invention further comprises collecting of said portion of the substrate. Preferably, said collecting of the portion of the substrate is performed in-line with providing, e.g. by extrusion, of said substrate, in that said portion of the substrate is continuously evacuated. By such setup, the method for manufacturing panels becomes even more automated and efficient. Moreover, the collected portion of the substrate material may be reused in the manufacturing of the panels. The collecting of the portion of the substrate is preferably done by a suction means, or a conveyor belt means.

In a preferred embodiment of the method according to the first aspect of the invention, said method further comprises the step of providing a decorative top layer, said decorative top layer preferably being provided on the side of the substrate opposite to the side wherefrom a portion of the substrate is removed. In such manner, said providing of the top layer can be done prior to or after the removing of at least said portion of the substrate by means of said at least one scraping tool.

In an alternative embodiment, the method according to the first aspect of the invention comprises a step of providing a top layer onto the side of the substrate wherefrom a portion of the substrate is removed. In a such way, the method allows further enhancing of the relief structures of the top layer.

The method according to the first aspect of the invention is particularly suitable for providing a top layer which comprises at least a decorative film, preferably a thermoplastic decorative film, such as a decorative PVC film, that may be a rigid film. Preferably said decorative film is printed with a decor, which decor may represent a wood structure, marble, stone, or the like patterns. The film, for example a rigid PVC film, is particularly preferred as being comprised in the top layer of the panels obtained through the method according to the first aspect of the invention. Rigid film may be less prone to expansion and other temperature induced changes which may occur during providing, preferably printing of the decor.

In a preferred embodiment of the method according to the first aspect of the invention, the decorative top layer comprises at least a wear layer on the top of the decorative film. Said wear layer is preferably comprising a thermoplastic material provided in a layer, for example having a thickness of 200 to 1000 μm. The wear layer preferably comprises PVC. In a particularly preferred embodiment, the wear layer is a PVC wear layer. Preferably, the wear layer is free from abrasion resistant particles.

In a preferred embodiment, the decorative top layer comprises a lacquer layer on the uppermost and/or outermost surface of the decorative top layer. Said lacquer layer is preferably a UV cured lacquer layer. Said lacquer layer may provide additional scratch resistance and additional aesthetic appearance.

Alternatively, a decorative top layer at least comprising a decorative layer including thermosetting resin may be used in the method according to the first aspect of the invention.

In a preferred embodiment of the method according to the first aspect of the invention, said removing of a portion of the substrate by means of at least one scraping tool is executed on a larger material comprising substrate material of a plurality of panels. Due to the versatility of the possible removal by means of at least one scraping tool, the method of the invention is particularly suitable for removal of a portion of the substrate from large surfaces.

In a particularly preferred embodiment of the method of invention, said removing of a portion of the substrate may be performed in line with an extrusion process, which extrusion may yield large sheets of substrate material. In another preferred embodiment, said removing of a portion substrate is executed on the respective part of the substrate having about the final dimensions of the panel to be obtained.

In a preferred embodiment, the method further comprises dividing of a larger substrate material into pieces about the final dimensions of the panel. Preferably this is done by cutting and/or sawing.

In a particularly preferred embodiment, the method further includes providing coupling means onto one or more pairs of opposite edges of said substrate. In a further preferred embodiment, said providing of coupling means includes sawing and/or milling of the coupling means. In a particularly preferred embodiment, providing of coupling means is performed after removing said portion of said substrate by means of said at least one scraping tool.

In one embodiment, the method according to the first aspect includes the step of removing a portion of said substrate from the upward directed surface of the substrate and providing the top decorative layer beneath the substrate, i.e. onto the downward directed surface of the substrate. The method according to this embodiment may be particularly suitable for positioning of at least one scraping tool above the production line and collection of the removed portion of the substrate by a suitable process, for example suction, while the top layer may be continuously provided, for example from a roll, onto the downward directed surface of the substrate.

In a preferred embodiment, the method according to the first aspect of the invention further comprises the step of providing a backing layer. Preferably, said method further comprises providing a backing layer onto the downward directed surface of the substrate, i.e. onto the side of said substrate opposite the side where the top layer material will be or is provided. In the preferred embodiment, the backing layer may be chosen to comprise a thermoplastic layer or a fiber based or a wood-based layer. Preferably, said backing layer is a bottom most layer or a damping layer. Preferably, said backing layer comprises soft thermoplastic material.

In a variant of the method according to the first aspect of the invention, the backing layer may be provided onto the upward directed surface of the substrate, while the top layer may be provided onto the downward directed surface of the substrate. The scraping tool, according to this variant, may be employed to remove a portion of the substrate on either of the upward directed or downward directed surfaces or on both.

It is noted that the provision of the substrate may as afore stated be done by means of extrusion. According to alternatives, granulate or powder scattering and consolidation methods may be used to provide the substrate. For example the method known per se from WO 2013/179261 may be used to provide the substrate.

It should be understood that a method for a provision of a substrate suitable for panels, wherein a portion of said substrate is removed by means of at least one scraping tool represents a separate and independent inventive aspect of the present invention. The provision of the substrate according to this inventive aspect of the invention may be realized according to any of the embodiments of the method according to the first aspect of the invention, without departing from the scope of the present invention.

With the same object as in the first aspect, according to an independent second aspect, the present invention also relates to a method for manufacturing panels comprising a substrate and a decorative top layer, wherein said method comprises at least the following steps:
providing said substrate at least in part by an extrusion process;
removing a portion of said substrate by a removal means;
   wherein said removing of the substrate is performed in-line with the extrusion process and wherein said substrate is provided in an orientation with an upward directed surface and a downward directed surface. It is clear that the method of the second aspect may further show the features of the first aspect of the invention and/or the preferred embodiments thereof.

In light of the present invention, the term “removing a portion of substrate” needs to be interpreted as removing a portion of said substrate following at least the extrusion process, more in particular, removing a material portion from an extruded substrate layer as obtained by at least the extrusion process. According to a first possibility, said portion may be completely detached from the extruded substrate layer. In such a case, the portion may be simply discarded, or alternatively, the portion may be reused, for example by returning it into the extrusion process. According to a second possibility, said portion may, instead of being completely detached, be displaced from its original position within the extruded substrate layer to form another part of the substrate.

Because the removal is in-line with the extrusion process, fewer conversion steps are needed to obtain the panel. The use of removal means instead of for example forming means leads to a better controllable process with less energetic demands.

Said removal means may be used to calibrate the thickness of the substrate and/or for providing recess in one or more of the downward or upward directed surfaces, for example recesses in the form of grooves, dashes or dots. Furthermore the form, shape, length and depth of the recesses may be adjusted.

According to one embodiment, following the aforementioned first possibility, in case said portion is completely detached from the extruded substrate layer, the thickness of the substrate layer, or at least parts thereof, may be decreased. More in particular, recesses may be provided in the form of grooves, dashes or dots.

According to another embodiment, following the aforementioned second possibility, in case said portion is reused in place, the thickness of said substrate layer, or at least parts thereof, may be increased. In this case, for example, the portion may be displaced from the extruded substrate layer towards a position adjacent to the surface of said extruded substrate layer, thereby increasing the total thickness of the substrate.

By preference, the portion may be displaced as such that the substrate is provided with one or more recesses, wherein the displaced portion forms a plurality of protrusions, ribs and/or ridges on the upward or downward directed surface of said substrate. This may have the particular advantage that a panel manufactured by means of the method of the present invention may be made thicker without increasing its total weight.

More by preference, the portion may be displaced as such that the plurality of protrusions, ribs and/or ridges circumscribe and/or demarcate at least one edge of said one or more recesses.

According to a particular embodiment, the mean diameter of the circumscribed circle of the one or more recesses and the mean width of the protrusions, ribs and/or ridges formed by the displaced portion are related according to a ratio between 2:1 and 10:1. By preference, the mean diameter of the circumscribed circle of the one or more recesses and the mean width of the protrusions, ribs and/or ridges formed by the displaced portion are related according to a ratio between 3:1 and 9:1, more by preference between 4:1 and 8:1.

According to some embodiments, the edge of said one or more recesses may have a round, oval, triangular, quadrangular, pentagonal, hexagonal, heptagonal or octagonal shape. According to some embodiments, said one or more recesses may have the same depth, or alternatively may have a varying depth. According to some embodiments, the depth of said recesses may be constant within a single recess, or alternatively, the depth within said recesses may vary within a single recess.

According to a particular embodiment, the mean diameter of the circumscribed circle of the one or more recesses and the mean width of the protrusions, ribs and/or ridges formed by the displaced portion are related according to a ratio between 2:1 and 10:1, wherein the edge of said one or more recesses has a hexagonal shape. By preference, the depth of said recesses varies within a single recess. More by preference, the depth of said recesses varies thereby forming a domed shape.

The method according to the second aspect of the invention is particularly suitable for a substrate comprising thermoplastic polymer material.

In a preferred embodiment, said providing of substrate is extruding said substrate, i.e. the substrate is preferably provided exclusively by extrusion.

In a preferred embodiment, said removal means for removing a portion of the substrate is a scraping tool and/or sawing tool. The method according to the second aspect of the invention is compatible with a wide variety of versatile substrate removal means, as long as said means can be arranged in-line with the extruding section. With reference to the aforementioned second possibility, a suitable removal means may be an embossing roller.

In a preferred embodiment, the method according to the second aspect of the invention further comprises the step of providing a decorative top layer, said decorative top layer preferably being provided on the side of the substrate opposite to the side wherefrom the portion of the substrate is removed. In a particularly preferred embodiment, the decorative top layer comprises at least a decorative film, preferably a rigid thermoplastic decorative film. Preferably the decorative film used in the method of the second aspect of the invention is the decorative film preferably used in the method of the first aspect of the invention.

In a further preferred embodiment of the method according to the second aspect of the invention, the decorative top layer comprises at least a wear layer on the top of the decorative film. Said wear layer is preferably the wear layer identical to the wear layer described in the method according to the first aspect of the invention. Preferably the decorative top layer of the second aspect of the invention comprises a lacquer layer as the uppermost layer of such top layer.

In a preferred embodiment, in the method according to the second aspect of the invention, said removing of a portion of the substrate is performed on the downward directed surface of the substrate. Alternatively, said removing of a portion of the substrate can be performed on the upward directed surface of the substrate or both on downward and upward directed surfaces of the substrate.

In a preferred embodiment of the method according to the second aspect, said removing of a portion of the substrate is executed on a larger material comprising substrate material of a plurality of panels. The large sheets of the substrate material exiting the extruding section may be particularly suitable to be further processed in the method according to the second aspect of the invention.

In an alternative embodiment of the method according to the second aspect, removing of at least a portion of the substrate is executed on the respective part of the substrate having about the final dimensions of the panel to be obtained.

In a preferred embodiment according to the second aspect of the invention, the method further comprises dividing of the larger substrate material into pieces about the final dimensions of the panel. In a further preferred embodiment, the method further includes providing coupling means onto one or more opposite edges of said substrate. In a particularly preferred embodiment, said providing of the coupling means includes sawing and/or milling. Preferably, said providing of the coupling means is performed after removing said portion of said substrate.

In a third independent aspect, the invention pertains to a method for manufacturing panels comprising a substrate and a decorative top layer, wherein said method comprises at least the following steps:
providing said substrate at least in part, wherein said substrate is provided in an orientation with an upward directed surface and a downward directed surface;
providing a decorative top layer onto the downward directed surface of the substrate.

The method according to a third aspect of the invention may be particularly suitable for panels which require more processing steps to be performed on the bottom side of the panel. By provision of a panel in a method of the third aspect, the bottom may be easier reachable and thus, if necessary, more efficiently processed.

In a particularly preferred embodiment, said providing of the substrate is extruding said substrate.

According to a particularly preferred embodiment, the method further comprises removing a portion of said substrate by a removal means.

In a further preferred embodiment, said removing of a portion of the substrate is performed in-line with the extruding of said substrate.

According to a preferred embodiment, said removal means employed in the method according to a third aspect of the invention is a scraping tool or a sawing tool.

Preferably, a method according to the third aspect of the invention further comprises providing of a decorative top layer. The decorative top layer used in the method is preferably of the same characteristics as the decorative top layer used in the method according to the first aspect.

In a particularly preferred embodiment according to a third aspect, said method further comprises a step of providing a backing layer onto the upward directed surface of the substrate. In the preferred embodiment, the backing layer comprises a thermoplastic layer or a fiber based- or a wood based-layer. Preferably, said backing layer is a bottom most layer or a damping layer. Preferably, said backing layer comprises soft thermoplastic material.

Preferably the method of invention according to any of its aspects is particularly suitable for panels comprising the substrates comprising at least a thermoplastic material, in particular a polymeric material. Preferably, said polymeric material is chosen from the list consisting of polyvinyl chloride (PVC), polyethylene (PE), polypropylene (PP), polyurethane (PU), and/or polyethylene terephthalate (PET) and/or polyester. The polymeric material may be a mixture of polymers chosen from the list consisting of PVC, PE, PP, PU, PET and/or polyester. Most preferably, the polymeric material used for a substrate is PVC, preferably PVC with less than 5 phr of plasticizer, or plasticizer free.

In a preferred embodiment, the substrate is SPC (Solid or Stone Plastic Composite), i.e. a filled synthetic composite material comprising thermoplastic material and an inorganic filler material, that is free or essentially free from foamed areas. In a further preferred embodiment, said substrate is any filled synthetic composite comprising, preferably mainly comprising, said, preferably thermoplastic, polymeric material and a filler material. In a particularly preferred embodiment, said substrate material essentially, i.e. at least for 95 wt. %, consists of said polymeric material and a filler material.

Various filler materials may be used in obtaining filled synthetic composite suitable to be used as a substrate in the method of the invention according to any of its aspects. Some of the non-limiting examples of said fillers are calcium carbonate (CaCO₃), sand, lime, kaolin, metakaolin, wollastonite, magnesium oxide, magnesium chloride, magnesium carbonate, glass, talc, carbon black, wood dust, bamboo dust, rubber, cork, straw, and paper. In a preferred embodiment, the filler material used in filled synthetic composite comprises at least calcium carbonate. Preferably, said filler is present in a content of at least 30 wt. %, preferably of at least 40 wt. %. In a particularly preferred embodiment, said substrate comprises calcium carbonate as a filler, preferably in a weight ratio with said polymeric material of 1:1 or larger, preferably of 2:1 or larger, wherein a weight ratio of 3.5:1 or larger is not excluded.

In an alternative embodiment according to the methods of the invention according to any of its aspects, said substrate has a foam structure. The foam structure consists basically of a thermoplastic matrix in which closed and/or open cells are present, preferably said foam is a closed-cell foam, i.e. a foam where at least the majority of the cells are closed. The foam structure may be obtained by adding blowing agents to the thermoplastic melt, before it is formed and hardened into its final shape. The foamed structure may be uniformly foamed or foamed that it forms locally denser areas, without departing from the scope of the invention.

The substrate of the panel provided by the method according to any of the above-mentioned aspects is preferably free from layers of reinforcement materials, such as glass fiber layers. It is not excluded however that said substrate material is reinforced, preferably by further comprising reinforcing materials. Various reinforcing materials may be present within the substrate material provided by the method of the invention according to any of its aspects, such as glass fiber, either randomly distributed as separate fibers, or in the form of a net or fleece of glass fiber.

In a preferred embodiment of the method according to any of its aspects, a depth of a recess provided on one of the surfaces of the substrate is at least 0.1 times a panel thickness, preferably at least 0.25 times a panel thickness, most preferably the depth of recess is 0.4 times than the panel thickness or larger and smaller than 0.7 times the panel thickness. The preferred depth leads to a considerable material saving, while maintaining a relatively strong panel, which panel may be suitable for provision of coupling means. This may be particularly favorable in case the panel is used as a floor panel, as the floor panel should be able to withstand serious impact during the normal use.

Preferably, the method of the invention according to any of its aspects comprises a further step of providing of coupling means on at least two opposite sides of the panel. The panel is provided with mechanical coupling means which make it possible for two such panels to be coupled to each other at the respective sides, an interlocking being produced in the coupled state, at least in a direction at right angles to the respective sides and in the plane of the panels. Preferably, in the coupled state, an interlocking is also produced in a direction at right angles to the plane of the panels on the respective sides. Preferably, the coupling means still have one or a combination of two or more of the following properties:

the property that the mechanical coupling means or coupling parts are substantially in the form of a tongue and a groove delimited by an upper lip and a lower lip, wherein this tongue and groove are substantially responsible for the interlocking in the aforementioned vertical direction, and wherein the tongue and the groove are provided with secondary locking parts, substantially responsible for interlocking in the aforementioned horizontal direction. Preferably, the locking parts comprise a locking groove on the bottom side of the edge with the tongue and a hook-shaped portion being provided on the bottom groove lip. Such coupling means and locking parts are known, for example, from WO 97/47834;

the property that the mechanical coupling means or coupling parts push the coupled panels against each other, for example because these mechanical coupling means are produced with so-called pretension, as is known per se from EP 1 026 341. The tension at which the panels are pressed against each other or towards each other may, for example, in combination with the above property, be achieved by means of a lower lip which is bent outwards in the coupled position and which presses against the bottom side of the tongue when it tries to spring back;
the property that the mechanical coupling means allow a coupling towards each other by means of a horizontal, or nearly horizontal, sliding movement of the panels;
the property that the mechanical coupling means allow a coupling by means of a turning movement W along the respective edges;
the property that the mechanical coupling means allow a coupling by means of a downwardly directed movement of a male coupling part, for example having a tongue, into a female coupling part, for example having a groove;
the property that the mechanical coupling means, or at least the associated top edge, is produced by means of a milling operation using rotating milling tools.

In a preferred embodiment, the portion of the substrate is removed in a such manner that the recesses obtainable thereby do not extend into the aforementioned mechanical coupling means on one or both of the respective opposite sides.

According to a particular embodiment of the method according to any aspect of the invention, the panel of the embodiment is rectangular, the aforementioned recesses run in the longitudinal direction of the panels, the panel is provided with coupling means on both the long pair and on the short pair of opposite sides. On the long pair of opposite edges, the panel is provided with mechanical coupling means which make a coupling by means of a turning movement W along the respective edges possible, wherein an interlocking is produced in the coupled state of two such long edges, both in a horizontal direction at right angles to the edges and in the plane of the panels, and in a vertical direction at right angles to the plane of the panels. The respective coupling means are substantially in the form of a tongue and a groove, with the groove being provided with a locking element on one of its lips flanking the groove, for example in the form of an upright portion on the bottom groove lip which can cooperate with a locking element on the tongue, for example in the form of a recess in the bottom side of the tongue. In the coupled state, at least horizontally active locking surfaces are produced on the aforementioned locking elements. Preferably, vertically active locking surfaces are produced between the top side of the tongue and the bottom side of the upper groove lip. The panel may be provided with similar coupling means on the short pair of opposite edges. Preferably, on the short pair of edges, the panel is provided with coupling means which enable coupling by means of a downwardly directed movement of a male coupling part, for example comprising a tongue, into a female coupling part, for example comprising a groove and/or at least comprising a lip which projects beyond the associated top edge. Preferably, the female coupling part is provided with a lip which projects beyond the associated top edge and this lip is provided with a locking element in the form of an upright portion which can cooperate with a locking element on the bottom side of the male coupling part, for example in the form of a recess in the bottom side of the male coupling part. In the coupled state, at least horizontally active locking surfaces are produced on the aforementioned locking elements. Preferably, vertically active locking surfaces are also produced in the coupled state. The vertically active locking surfaces may coincide with the aforementioned horizontal locking surfaces and/or comprise separate surfaces.

In a particularly preferred embodiment, the method according to any of the first, second or the third aspect of the invention is particularly suitable for manufacturing of floor, wall or furniture panels.

As mentioned here above, it is noted that initially the method of the invention according to any of its aspects preferably leads to provision of larger substrate sheets comprising the substrate preferably with the decorative top layer. Such large sheets may be further divided by an additional dividing step, so that the panels are obtained, which panels have the size or approximately the size of the panels to be finally obtained. The dividing step may be performed by means of cutting, punching, sawing or the like. After division preferably further finishing steps may be performed for example with the aim of forming the coupling means at the edges of the panels.

In a preferred embodiment, the method according to any one of the aspect of the invention, provides a panel with a surface texture. The surface texture may be provided on the decorative top layer, by for example embossing in an optional embossing step. In a preferred embodiment, the surface texture can be provided on the upper surface of the top layer, in the form of a relief, which, for example, imitates a real surface structure, for example, of wood or the like.

During the optional embossing step, the surface texture can be applied onto the top layer which will preferably match the underlying decor layer in the panel obtainable by the method according any of the first, second or a third aspect of the invention. This can be achieved using a registered embossing technique wherein the texture is applied to the top layer of the panel so that the texture matches the decor layer. For example, if the decorative top layer includes the image of a wood grain, the top layer is embossed with a wood grain texture that matches the decor layer, and thus provides the impression and feel of a natural wood product.

With the intention of better showing the characteristics according to the invention, in the following, as an example without limitative character, an embodiment is described, with reference to the accompanying drawings, wherein:

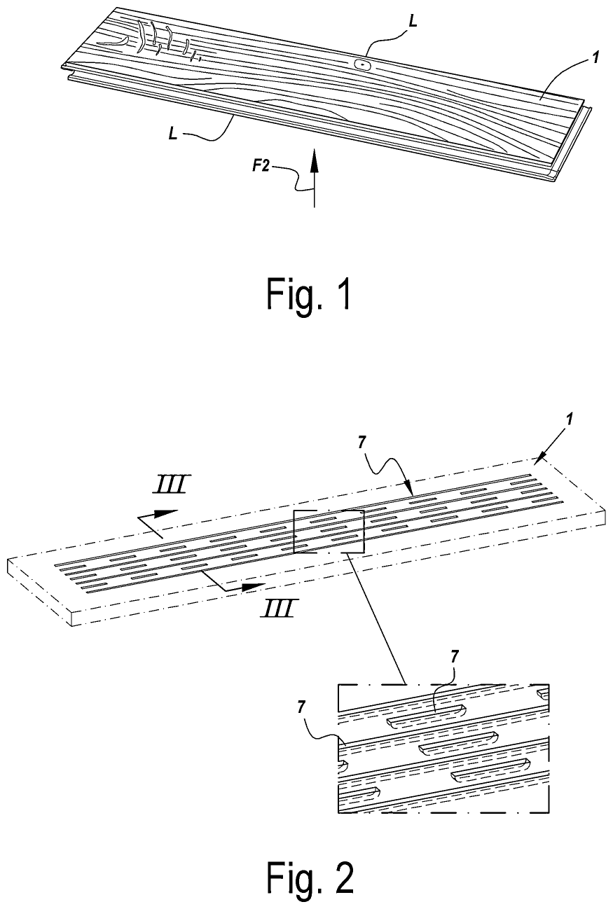

FIG. 1 schematically shows a top view of a panel obtainable by a method according to any of the first, second and third aspects of the invention;

FIG. 2 on larger scale schematically shows a bottom-up view of the panel in FIG. 1 in the direction marked as F2 in FIG. 1;

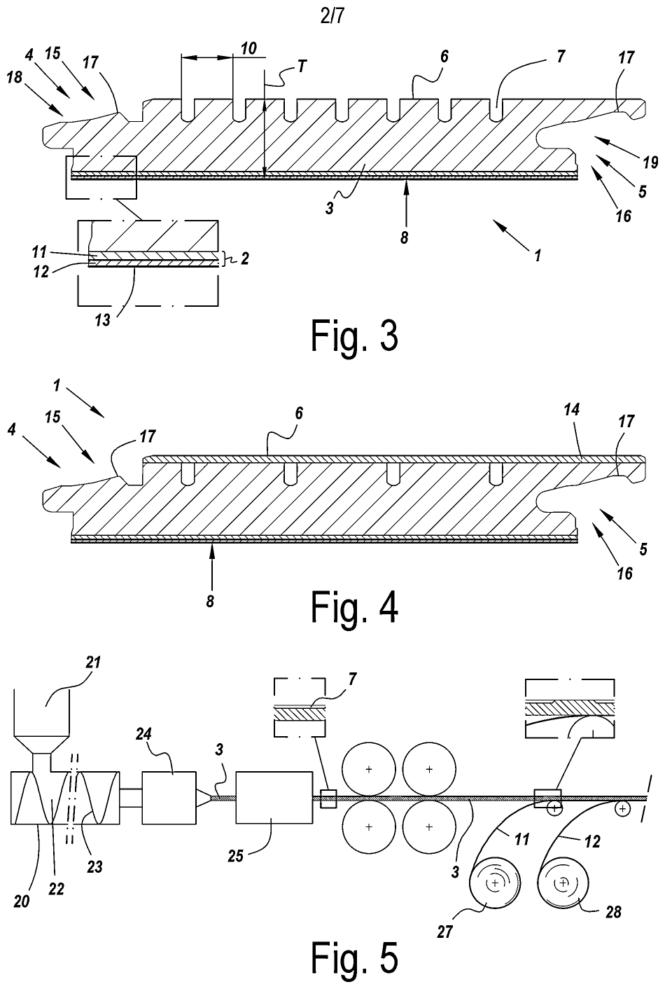

FIG. 3 shows schematically and on a larger scale, a cross-section according to line III-III in FIG. 2;

FIG. 4 shows schematically a cross-section of a variant of the panel obtainable by a method according first or second aspect of the invention,

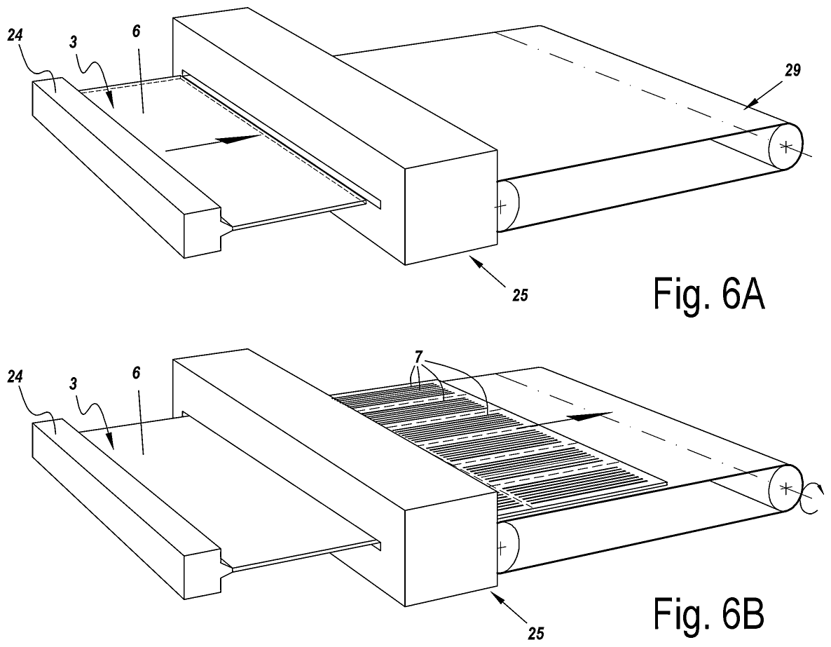

FIG. 5 shows some steps in a method according to the third aspect of the invention;

FIGS. 6A and 6B represent a view on the substrate of the panel passing through the substrate removal section;

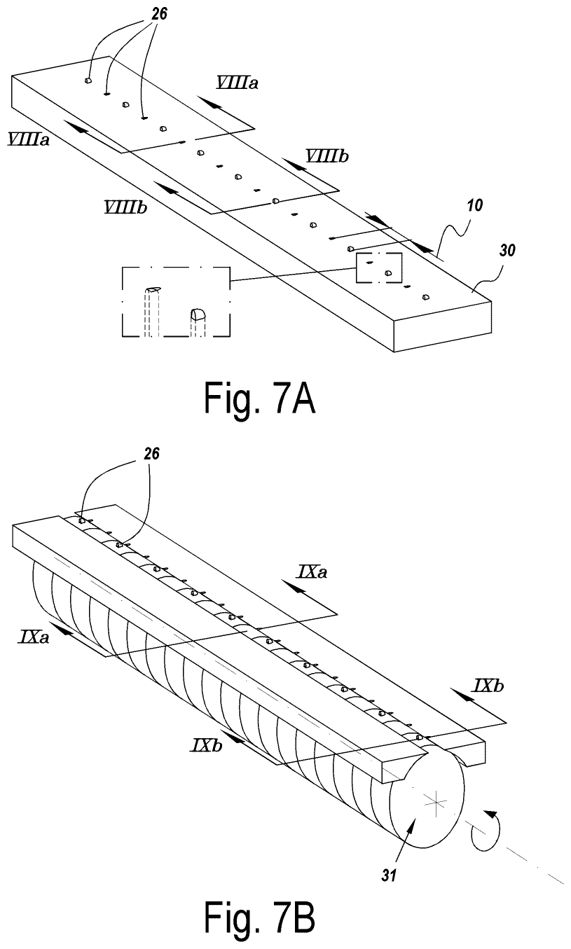

FIGS. 7A and 7B represents a top view on alternatives of a plurality of scraping tools positioned on a support means;

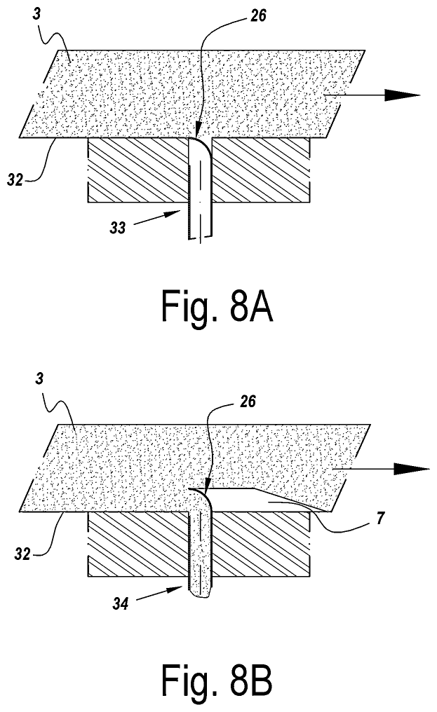

FIGS. 8A and 8B on a larger scale, represent a cross section of the scraping tool removing a part of the substrate according to line VIIIa-VIIIa and VIIIb-VIIIb in FIG. 7A respectively;

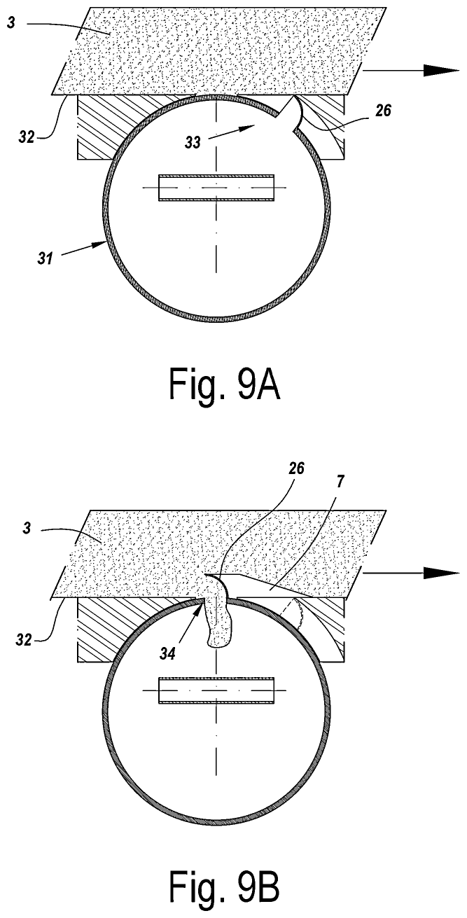

FIGS. 9A to 9B on a larger scale represent a cross section of the scraping tool removing a part of the substrate according to line IXa-IXa and IXb-IXb in FIG. 7B, respectively;

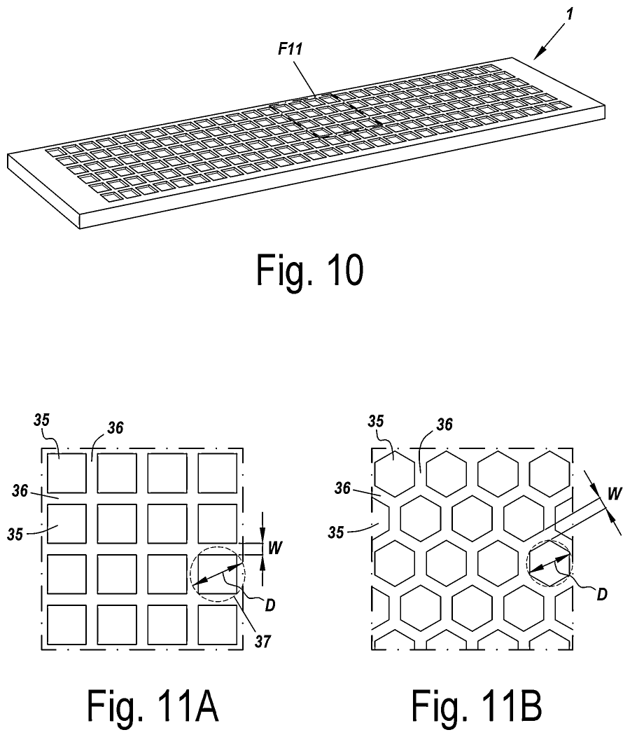

FIG. 10 schematically shows a bottom-up view of a panel obtainable by a method according to the second aspect of the invention;

FIG. 11A shows a bottom view of a portion of the panel according to F11 in FIG. 10; and

FIG. 11B in a same view as FIG. 11B represents a variant.

In the represented example, as depicted in FIGS. 1-4, the panel 1, which is produced by a method according to any of the first or the second aspect of the invention, comprises the decorative top layer 2, the substrate material 3 preferably provided with coupling means 4-5 on both short and long edges of the panel 1. Onto the upward directed surface 6 which is oriented on a surface of the substrate 3 opposite to the surface where the top layer 2 is provided, a plurality of recesses in form of grooves 7 are provided. Is should be understood that the plurality of recesses in form of grooves 7 can be provided on a downward directed surface 8, or both upward directed surface 6 and downward directed surface 8, without departing from the scope of the invention. The grooves are provided by a substrate removal means, said removal means preferably being a scraping tool 9. In the embodiment of FIG. 2, said grooves 7 are extending in the longitudinal direction of the panel 1, i.e. said grooves are parallel to the long edges L of the panel 1.

FIG. 3 represents a preferred embodiment of a panel 1 obtainable by method of any of the aspects of the invention. The provided grooves 7, have depths of at least 0.1 times a panel thickness T, and are provided at a distance 10 from each other, which can be varied. This may be for example a depth of about 0.3-0.5 mm in the substrate 3. The groove 7 may be U shaped as in FIG. 2, or, for example V shaped. In FIG. 2, the decorative top layer 2 is provided on the side of the substrate opposite to the grooves 7. The top layer 2 of the panel in FIG. 3, which top layer 2 is on the downward directed surface 8, preferably comprises a printed PVC foil 11, thermoplastic wear layer 12 and a lacquer layer 13 as the outermost layer of the decorative top layer 2.

The embodiment in FIG. 4 shows a variant of a panel 1 obtained by any of the first, second or a third aspect of the invention, said panel 1 comprising additionally a backing layer 14. The backing layer 14 is preferably a soft thermoplastic layer.

In FIGS. 1 to 4, a floor panel 1 is shown, but it should be understood that a panel of the invention may be suitable for other uses, for example as a wall or celling panel of as a furniture panel.

The panel 1 can be of various shape, for example, rectangular or square, or of any other shape, depending on the use.

As shown in FIGS. 1, 3 and 4, preferably each panel 1 is, at least at the edges 15-16 of two opposite sides, provided with coupling means 4-5 which allow that two adjacent panels 1 can be coupled to each other. The coupling means 4-5, as represented in the FIGS. 1, 3 and 4, are provided with integrated mechanical locking means 17 which prevent the drifting apart of two coupled panels 1; the coupling 4-5 and the locking means 17 are realized preferably in one piece with the substrate material 3 of the panels 1.

The coupling parts 4-5 can be realized in various forms, although the basic forms are preferably formed, as in the example, by a tongue 18 and a groove 19.

FIG. 5 shows a possible embodiment of the method according to the third aspect of the invention as well as schematically represents the installation applied therewith. In FIG. 5 an installation comprises an extruder 20 for extruding the substrate material 3. In FIG. 5, the preferred equipment, comprises a vessel 21 for preparation of the powder and/or granulate comprising substrate material, i.e. preferably at least a polymer material and a filler. Said granulate is fed to the extruder 20. The extruder 20 is equipped by an extruding section 22 which comprises at least one screw 23, whereby the molten substrate material is pushed to and through a die 24. In a preferred embodiment, said die 24 is a flat die, having an opening corresponding to the dimensions of the substrate material to be obtained, for example 2 to 5 mm thick and 0.8 to 2.1 m wide, wherein a width of about 1.3 m is preferred. Said die 24 allows for obtaining a substantially flat layer of an extruded thermoplastic substrate material. In a most preferred embodiment, said extruded substrate 3 is directed through a scraping section 25 equipped by a scraping tool 9 in the form of put forth and/or retractable knives 26. In the embodiment of FIG. 5, a portion of the substrate 3 is removed by said scraping tool 9 from the upward directed surface, while layers of the decorative top layer 2, the layers being a printed PVC foil 11 and a thermoplastic wear layer 12 are provided from rolls 27 and 28, respectively onto the downward directed surface of the substrate 3.

FIGS. 6A and 6B show conveying of the substrate 3 of a panel 1 through a scraping section 25 on a conveyor belt 29. In the scraping section 25, preferably a scraping tool 9 removes a portion of the substrate 3 and as a result a plurality of grooves 7 are present on an upward directed surface 6 of the substrate 3.

FIG. 7A shows a plurality of scraping tools 9 in a form of knives 26 which are positionable, i.e. put forth and/or retractable from the support means, which support means is a plank 30. The distance between the two knives 26 on the plank 30 would determine the distance 10 between the two grooves 7 on a panel 1.

FIG. 7B shows another variant of a plurality of scraping tools 9, in a form of knives 26, which knives 26 are arranged onto a rotating means 31. The distance between the two knives 26 on a rotating means 31 would determine the distance 10 between the two grooves 7 on a panel 1

FIGS. 8A and 8B show different stages in forming of a groove 7 in the substrate 3 by a scraping tool 9 in a form of a knife 26 as shown in FIG. 7A. FIG. 8A shows the scraping tool 9 in a form of knife 26 which engages intermittently with a surface 32 of the substrate 3, wherein positioning of said knife 26 is used to start the engagement with the surface 32. Said surface 32 can be either an upward directed surface 6, a downward directed surface 8 or both of said surfaces 6, 8 in some embodiments. In FIG. 8A, the knife 26 is shown in a retracted position 33, in which retracted position no portion of the substrate 3 is removed. In FIG. 8B, the knife 23 is in an active, put forth position 34, in which active position 34 the knife 26 cuts through a surface 32 of the substrate 3, providing a groove 7 therein. The depth and the diameter of a groove 7 can be controlled by positioning of the knife 26.

FIGS. 9A and 9B show different stages in forming of a groove 7 in the substrate 3 by a scraping tool 9 placed on a rotating means 31, as shown in FIG. 7B. FIG. 9A shows the scraping tool 9 in a form of knife 26 which engages intermittently with at the surface 32 of the substrate 3, wherein positioning of said knife 26 is used to start the engagement with a surface 32. Said surface 32 can be either an upward directed surface 6, a downward directed surface 8 or both of said surfaces 6, 8 in some embodiments. In FIG. 9A, the knife 26 is shown in a retracted position 33, in which retracted position no portion of the substrate 3 is removed. In FIG. 9B a knife 26 is in an active, put-forth position 34, in which active position 34 the knife 26 cuts through the surface 32 of the substrate 3, providing a groove 7 therein. The depth and the diameter of a groove 7 can be controlled by positioning of the knife 26. Positioning of the knife 26 on the rotating means 31 along a direction parallel to the rotation axis of the rotating means 31, as well as rotation parameters of said rotating means 31 may influence the depth and the distance 10 between two grooves 7. Moreover, since the knife 26 can be in a retracted position 33 or put-forth position 34 independent of position of other knives 26 and independent of the rotation parameters of the rotation means 31, a greater flexibility of the removal of the substrate 3 is achieved, as well as a greater variability in the grooves 7 obtained thereby.

FIG. 10 shows a panel 1 obtainable by a method according to the second aspect of the invention, said panel is oriented bottom-side up, and comprises a plurality of recesses 35 which are formed by removing a portion of substrate, in particular by displacing a portion of substrate from its original position within the extruded substrate layer to form another part of the substrate. Said other part of the substrate is formed as a plurality of ridges 36, which ridges 36 demarcate the edges of the recesses 35. As a result of the displacement of the portion of substrate, the substrate may be thicker than the original extruded substrate layer without the addition of weight thereto.

FIG. 11A shows a bottom view of a portion of the panel of FIG. 10 according to F11. The recesses 35 have a square shape and are dimensioned as such that the mean diameter D of the circumscribed circle 37 of the recesses 35 and the mean width W of the ribs 36 formed by the displaced portion are related according to a ratio between 2:1 and 10:1. A variant is shown in FIG. 11B, wherein the shape of the recesses 35 is hexagonal. Although not explicitly shown, it may be that said recesses 35 have the same depth. Preferably however, said recesses 35 have a varying depth, such as an increasing depth moving from the edges of the panel towards the center of the panel. Furthermore, it may also be that the depth of said recesses 35 is constant within a single recess, or alternatively, the depth within said recesses may vary within a single recess. By preference, the depth of a single recess varies according to a domed shape.

The invention is further disclosed by the following paragraph list as defined by the below numbered paragraphs.

1.—Method for manufacturing panels 1 comprising a substrate 3 and a decorative top layer 2, wherein said method comprises at least the following steps:
providing said substrate 3 at least in part;
removing a portion of said substrate 3 by means of at least one scraping tool 9,
wherein said substrate 3 is provided in an orientation with an upward directed surface 6 and a downward directed surface 8.

2.—Method according to numbered paragraph 1, characterized in that said step of removing of the portion of said substrate 3 is performed on at least one of the upward directed surface 6 or the downward directed surface 8.

3.—Method according to any one of numbered paragraphs 1 or 2, characterized in that said at least one scraping tool 9 is positionable.

4. Method according to any one of numbered paragraphs 1 or 3, characterized in that at least one scraping tool 9 is provided on a support means 30, 31, said at least one scraping tool 9 being put forth and/or retractable.

5.—Method according to any one of the preceding numbered paragraphs, characterized in that said providing of said substrate 3 at least comprises extruding said substrate 3 at least in part.

6.—Method according to any one of the preceding numbered paragraphs, characterized in that said part of said substrate 3 is provided in a continuous manner, wherein said removing is in line with said providing of at least said part of said substrate 3.

7.—Method according to any one of the preceding numbered paragraphs, characterized in that said part of said substrate 3 is only partially consolidated prior to the step of removing the portion of said substrate 3.

8.—Method according to any one of numbered paragraphs 1 to 6 wherein said part of said substrate 3 is fully consolidated prior to the step of removing the portion of said substrate 3.

9.—Method according to any one of the proceeding numbered paragraphs, characterized in that said method further comprises collecting of the portion of the substrate 3 removed by means of at least one scraping tool 9.

10. Method according to numbered paragraph 9, characterized in that said collecting is in-line with providing of said substrate 3.

11.—Method according to any one of the preceding numbered paragraphs, characterized in that said method further comprises the step of providing a decorative top layer 2, said decorative top layer 2 preferably being provided on a side of the substrate 3 opposite to a side wherefrom a portion of the substrate 3 is removed.

12.—Method according to any one of the preceding numbered paragraphs, characterized in that said removing of said portion of the substrate 3 is performed on the downward directed surface 8 of the substrate 3.

13.—Method according to any one of numbered paragraphs 1 to 8, characterized in that said removing of said portion of the substrate 3 is performed on the upward directed surface 6 of the substrate 3.

14.—Method according to any one of the preceding numbered paragraphs, characterized in that said removing of a portion of the substrate 3 is executed on a larger substrate material comprising substrate material of a plurality of panels 1.

15.—Method according to numbered paragraph 14, characterized in that the method further comprises dividing of said larger substrate material into pieces having about the final dimensions of the panel 1, said substrate material comprising edges 15-16.

16.—Method according to any one of the numbered paragraphs 1 to 13, characterized in that said removing of a portion of the substrate 3 is executed with the respective part of the substrate 3 having about the final dimensions of the panel 1 to be obtained.

17.—Method according to numbered paragraph 15, characterized in that the method further includes providing coupling means 4-5 onto said edges 15-16.

18.—Method according to numbered paragraph 17, characterized in that said providing of the coupling means 4-5 includes sawing and/or milling.

19.—Method according to any one of numbered paragraphs 15 or 17 to 18, characterized in that said providing of the coupling means 4-5 is performed after removing of a portion of said substrate 3 by means of at least one scraping tool 9.

20.—Method according to any one of the proceeding numbered paragraphs, characterized in that said method further comprises providing a backing layer 14 onto the downward directed surface 8 of the substrate 3.

21.—Method according to any one of numbered paragraphs 1 to 19, characterized said method includes the step of removing of a portion of said substrate 3 from the upward directed surface 6 of the substrate 3 and providing the top decorative layer 2 onto the downward directed surface 8 of the substrate 3.

22.—Method according to numbered paragraph 21, characterized in that said method further includes the step of providing a backing layer 14 onto the upward directed surface 6 of the substrate 3.

23.—Method for manufacturing panels 1 comprising a substrate 3 and a decorative top layer 2, wherein said method comprises at least the following steps:
providing said substrate 3 at least in part by an extrusion process;
removing a portion of said substrate 3 by a removal means;
wherein said removing of the substrate 3 is performed in-line with the extrusion process and wherein said substrate 3 is provided in an orientation with an upward directed surface 6 and a downward directed surface 8.

24.—Method according to numbered paragraph 23, characterized in that said portion of said substrate 3 is displaced from its original position within the extruded substrate layer to form another part of the substrate 3.

25.—Method according to numbered paragraph 24, characterized in that said portion of said substrate 3 is displaced such that the substrate 3 is provided with one or more recesses 35, wherein the displaced portion forms a plurality of protrusions, ribs and/or ridges 36 on the upward directed surface 6 or the downward directed surface 8.

26.—Method according to numbered paragraph 25, characterized in that the plurality of protrusions, ribs and/or ridges 36 circumscribe and/or demarcate at least one edge of said one or more recesses 35.

27.—Method according to numbered paragraphs 24 or 25, characterized in that the mean diameter D of the circumscribed circle 37 of the one or more recesses 35 and the mean width W of the protrusions, ribs and/or ridges 36 are related according to a ratio between 2:1 and 10:1.

28.—Method according to numbered paragraph 23, characterized in that said providing of substrate 3 is extruding said substrate 3.

29.—Method according to any one of numbered paragraphs 23 or 28, wherein said removal means is a scraping tool 9 or sawing tool.

30.—Method according to any one of numbered paragraphs 23 to 29, characterized in that said part of said substrate 3 is only partially consolidated prior to the step of removing the portion of said substrate 3.

31.—Method according to any one of numbered paragraphs 23 to 29 wherein said part of said substrate 3 is fully consolidated prior to the step of removing of the portion of said substrate 3.

32.—Method according to any one of numbered paragraphs 23 to 31, characterized in that said method further comprises the step of providing a decorative top layer 2, said decorative top layer 2 preferably being provided on a side of the substrate 3 opposite to a side wherefrom said portion of the substrate 3 is removed.

33.—Method according to any one of numbered paragraphs 23 to 32, characterized in that said removing of a portion of the substrate 3 is performed on the downward directed surface 8 of the substrate 3.

34.—Method according to any one of numbered paragraphs 23 to 31, characterized in that said removing of a portion of the substrate 3 is performed on the upward directed surface 6 of the substrate 3.

35.—Method according to any one of numbered paragraphs 23 to 34, characterized in that said removing is executed on a larger substrate material comprising substrate material of a plurality of panels 1.

36.—Method according to any one of numbered paragraphs 23 to 34, characterized in that said removing is executed with the respective part of the substrate 3 having about the final dimensions of the panel 1 to be obtained.

37.—Method according to numbered paragraph 35, characterized in that the method further comprises dividing of said larger substrate material into pieces having about the final dimensions of the panel 1, said substrate material comprising edges 15-16.

38.—Method according to numbered paragraph 37, characterized in that said method further includes providing coupling means 4-5 onto said edges 15-16.

39.—Method according to numbered paragraph 38, characterized in that said providing the coupling means 4-5 includes sawing and/or milling.

40.—Method according to any one of numbered paragraphs 38 to 39, characterized in that said providing the coupling means 4-5 is performed after said removing a portion of said substrate 3.

41.—Method for manufacturing panels comprising a substrate 3 and a decorative top layer 2, wherein said method comprises at least the following steps:
providing said substrate 3 at least in part, wherein said substrate 3 is provided in an orientation with an upward directed surface 6 and a downward directed surface 8; and
providing a decorative top layer 2 onto the downward directed surface 8 of the substrate 3.

42.—Method according to numbered paragraph 41, characterized in that said providing of the substrate 3 is extruding said substrate 3.

43.—Method according to any one of numbered paragraphs 42, characterized in that said method further comprises removing a portion of said substrate 3 by a removal means.

44.—Method according to numbered paragraph 43, characterized in that said removing of the substrate 3 is performed in-line with extruding said substrate 3.

45.—Method according to any one of numbered paragraphs 43 or 44, characterized in that said removal means is a scraping tool 9 or a sawing tool.

46.—Method according to any one of numbered paragraphs 41 to 45, characterized in that said method further comprises a step of providing a backing layer 14 onto the upward directed surface 6 of the substrate 3.

The present invention is in no way limited to the above described embodiments, and such methods may be realized according to several variants without departing from the scope of the invention.

1-46. (canceled)

47. A method for manufacturing panels comprising a substrate and a decorative top layer, wherein said method comprises at least the following steps:
providing said substrate at least in part by an extrusion process;
removing a portion of said substrate by a removal means;
wherein said removing of the substrate is performed in-line with the extrusion process and wherein said substrate is provided in an orientation with an upward directed surface and a downward directed surface.

48. The method according to claim 47, wherein said portion of said substrate is displaced from its original position within the extruded substrate layer to form another part of the substrate.

49. The method according to claim 48, wherein said portion of said substrate is displaced such that the substrate is provided with one or more recesses, wherein the displaced portion forms a plurality of protrusions, ribs and/or ridges on the upward directed surface or the downward directed surface.

50. The method according to claim 49, wherein the plurality of protrusions, ribs and/or ridges circumscribe and/or demarcate at least one edge of said one or more recesses.

51. The method according to claim 48, wherein the mean diameter of the circumscribed circle of the one or more recesses and the mean width of the protrusions, ribs and/or ridges are related according to a ratio between 2:1 and 10:1.

52. The method according to claim 47, wherein said removal means is a scraping tool or sawing tool.

53. The method according to claim 52, wherein said removal means is a scraping tool,
wherein said scraping tool is positionable.

54. The method according to claim 52, wherein at least one scraping tool is provided on a support means, said at least one scraping tool being put forth and/or retractable.

55. The method according to claim 47, wherein said part of said substrate is only partially consolidated prior to the step of removing the portion of said substrate.

56. The method according to claim 47, wherein said part of said substrate is fully consolidated prior to the step of removing of the portion of said substrate.

57. The method according to claim 47, wherein said method further comprises the step of providing a decorative top layer, said decorative top layer being provided on a side of the substrate opposite to a side wherefrom said portion of the substrate is removed.

58. The method according to claim 57, wherein said decorative top layer comprises at least a decorative film, at least a wear layer on the top of the decorative film, and a lacquer layer as the uppermost layer of said decorative top layer.

59. The method according to claim 47, wherein said removing of a portion of the substrate is performed on the downward directed surface of the substrate.

60. The method according to claim 47, wherein said removing of a portion of the substrate is performed on the upward directed surface of the substrate.

61. The method according to claim 47, wherein said removing is executed on a larger substrate material comprising substrate material of a plurality of panels.

62. The method according to claim 47, wherein said removing is executed with the respective part of the substrate having about the final dimensions of the panel to be obtained.

63. The method according to claim 61, wherein the method further comprises dividing of said larger substrate material into pieces having about the final dimensions of the panel, said substrate material comprising edges.

64. The method according to claim 63, wherein said method further includes providing coupling means onto said edges.

65. The method according to claim 64, wherein said providing the coupling means includes sawing and/or milling.

66. The method according to claim 64, wherein said providing the coupling means is performed after said removing a portion of said substrate.
